(19) United States
(12) Patent Application Publication
(10) Pub. No.: US 2017/0300844 A1
(43) Pub. Date: Oct. 19, 2017

(54) SYSTEM AND METHOD FOR THE MONITORING AND GUIDING OF PROJECTS

(71) Applicant: SYNERGY TECHNOLOGY SOLUTIONS, LLC, Salt Lake City, UT (US)

(72) Inventors: Steven P. Urry, Park City, UT (US); Sloan Urry, Salt Lake City, UT (US); Joanna G. Boice, Salt Lake City, UT (US)

(73) Assignee: SYNERGY TECHNOLOGY SOLUTIONS, LLC, Salt Lake City, UT (US)

(21) Appl. No.: 15/481,898

(22) Filed: Apr. 7, 2017

Related U.S. Application Data
(60) Provisional application No. 62/324,015, filed on Apr. 18, 2016.

(51) Int. Cl. G06Q 10/06

(52) U.S. Cl. CPC G06Q 10/06313; G06Q 10/0639

(57) ABSTRACT

A system for the monitoring and guiding of a construction project is disclosed. The system may forecast a metric through the completion of the project. The system may provide a mechanism for automated project team member compliance verification by reviewing, analyzing, and forecasting a target metric related to project team members. The system may also guide the project by identifying tasks that may deter the project from its critical path if the task was delayed or failed. The tasks may be assigned various alert values based on the importance of the task. The system may quantify in real time the potential financial and scheduling impact of the task. The system may prioritize and rank the tasks based on the quantification.

### CROSS-REFERENCE TO RELATED APPLICATIONS

This application is a nonprovisional of, claims priority to and the benefit of, U.S. Provisional Application No. 62/324,015 filed Apr. 18, 2016 and entitled SYSTEM AND METHOD FOR THE MONITORING AND GUIDING OF PROJECTS, which is hereby incorporated by reference in its entirety.

### FIELD

The disclosure generally relates to project monitoring, and more specifically, to systems and methods for monitoring and guiding projects.

### BACKGROUND

Construction projects may involve a variety of managers, contractors, subcontractors, bankers, and other additional parties. Each party may be involved in a different task and/or portion of the construction project, and each task may be dependent on the completion of other tasks that may be assigned to other parties. A large amount of money may be spent on regulations and risk mitigation prior to a bank issuing a loan for the construction project, but a great amount of risk still exists during the life of the construction project, as the delay of a single task may jeopardize and/or delay the entire project. Because of the number and dependency of tasks spread amongst a plurality of parties, it may become difficult to identify potential issues before the issues reach a critical crisis in the project. Currently, a system does not exist that allows a bank, along with all of the other parties involved, access and transparency to the lifecycle and completion of the various tasks for the construction project. As such, there is an increased need for systems and methods to provide greater efficiency, transparency, insight, and increased visibility to construction projects.

### SUMMARY

In various embodiments, systems, methods, and articles of manufacture (collectively, “the system”) for the monitoring and guiding of construction projects are disclosed. In various embodiments, the system may be configured to forecast a metric through the completion of a project. A target metric communications server may receive a target metric for the project. The target metric communications server may transmit the target metric to a worker aggregation engine. The worker aggregation engine may aggregate a plurality of electronic records from a worker database, each electronic record comprising a worker data set and may correspond to workers who work on the project. A historical performance factoring node may obtain historical factor information corresponding to each worker, and may associate the historical factor information with the worker data set.

A metric impact scoring server may receive the target metric from the target metric communications server, via a forecasting system bus, in response to a first exchange directive from a real-time bus supervisor. The metric impact scoring server may receive the worker data set from the worker aggregation engine, via the forecasting system bus, in response to a second exchange directive from the real-time bus supervisor. The metric impact scoring server may receive the historical factor information from the historical performance factoring node, via the forecasting system bus, in response to a third exchange directive from the real-time bus supervisor. The metric impact scoring server may assign each of the workers a metric impact score based on a score computation engine configured to ingest the target metric, the worker data set, and the historical factor information. The metric impact scoring server may transmit a first adjustment instruction to the target metric communications server, via the forecasting system bus. The first adjustment instruction may comprise a directive to vary the target metric in response to the metric impact score, whereby the metric impact scoring server may ingest the first adjustment instruction, and in response, transmit a metric forecast to the forecasting system bus.

A user interaction module may retrieve the metric forecast from the forecasting system bus. The user interaction module may display a first visual cue in response to the metric forecast being equal to or less than the target metric. The user interaction module may display a second visual cue, distinguishable from the first visual cue, in response to the metric forecast being greater than the target metric. The real-time bus supervisor may also direct the target metric communications server, the worker aggregation engine, the historical performance factoring node, and the metric impact scoring server, to repeat the abovementioned steps in response to a plurality of predefined triggers.

In various embodiments, the historical factor information may be timeliness. The metric may be time to completion. The historical factor information may be based on geofencing. The historical factor information may be financial, and the metric may be cost to completion. The historical factor information may also be credit worthiness, and the metric may be risk of default.

In various embodiments, the system may be configured to guide a project. A task identification server may retrieve a library of defined tasks from a task database. The task identification server may be in logical communication with the task database by a first task identification bus. A first task identification controller may be in logical communication with the first task identification bus, and may instruct the task identification server to identify a first task. The first task identification controller may transmit the first task to an alert value computation engine wherein the first task identification controller and the alert value computation engine may be in logical communication via the first task identification bus. The alert value computation engine may assign an alert value to the first task in response to an instruction from the first task identification controller. The alert value computation engine may compare the alert value to an alert condition. A user interaction module may be in logical communication with the first task identification controller via the first task identification bus, and may display a first visual cue in response to the alert condition not being met. The alert value computation engine may increase the alert value by a first factor and direct the user interaction module to adjust the first visual cue in a first way if the first task has a first successor task dependent upon the first task. The alert value computation engine may increase the alert value by a second factor and direct the user interaction module to adjust the first visual cue in a second way distinguishable from the first way if the first successor task has a second successor task dependent upon the first successor task.

In various embodiments, the alert condition may be schedule. The alert condition may be budget. The alert condition may also be a first capitalization ratio. The first capitalization ratio may comprise a subcontractor liquidity estimate.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for forecasting a metric through completion of a project, in accordance with various embodiments;

FIG. 2 is a block diagram illustrating various sub-system components of a system for guiding a project, in accordance with various embodiments;

FIG. 3 illustrates a process flow for forecasting a metric through completion of a project, in accordance with various embodiments;

FIG. 4 illustrates a process flow for guiding a project, in accordance with various embodiments;

FIG. 5 illustrates a method of guiding a project, in accordance with various embodiments;

FIG. 6 illustrates a method of guiding a project, in accordance with various embodiments;

FIG. 7 illustrates a method of forecasting a target metric with a user prompted interface, in accordance with various embodiments;

FIGS. 8-10 illustrate a method of guiding a project, in accordance with various embodiments;

FIGS. 11-13 illustrate various exemplary tasks for a method of guiding a project, in accordance with various embodiments; and

FIG. 14 is a flow chart illustrating various user prompted interfaces, in accordance with various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, the system may be configured to guide and monitor a project throughout the project's lifecycle or any portion of the lifecycle. Instead of focusing solely on the regulations and risk mitigation at the beginning of the project, the system may holistically and continuously monitor and guide the project end-to-end (or any portion thereof, including before the start date and/or after the end date). In this regard, the system may guide and prioritize any tasks (e.g., critical tasks or non-critical tasks) that may need completion, before the collateral and overall construction project is at risk. Moreover, the system may enable bankers, contractors, subcontractors, owners, developers, architects, engineers, lawyers, accountants, and/or other similar parties (collectively, “Interested Parties”), to initiate and monitor the project throughout any portion or all of its lifecycle, thus providing an efficient, cost-saving tool while also enabling greater transparency, visibility, and insight. The system may also streamline the “draw process”, while increasing the visibility into compliance (legal, financial, and otherwise) of the Interested Parties, and the cash flow requirements of the project. The draw process may refer generally to the multi-step process and/or schedule wherein a bank withdraws the loan money to pay the construction parties for tasks completed throughout the construction project. The system may also increase the efficiency of communications between computer modules by centralizing data, removing and/or limiting redundant data, and limiting the display and use of data based on a defined role.

While the foregoing may make reference to the projects as “construction projects”, it should be recognized by one skilled in the art that the present disclosure may extend to any suitable type of project and/or process that can be facilitated using the disclosed system. For example, the present disclosure may extend to software development projects, process lifecycle management, business process management, and transactional management systems such as, for example, systems for commercial real estate, mergers and acquisitions, advertising agencies, legal work flow, and/or the like. In addition, persons skilled in the art will appreciate that the present disclosure can be used not only to manage a business process, but also in connection with pre business process due diligence and post business process tracking. In various embodiment, the present disclosure can use used in connection with various systems and methods for document management, and more specifically, for managing and synchronizing documents across multiple folders for multiple users with different access privileges.

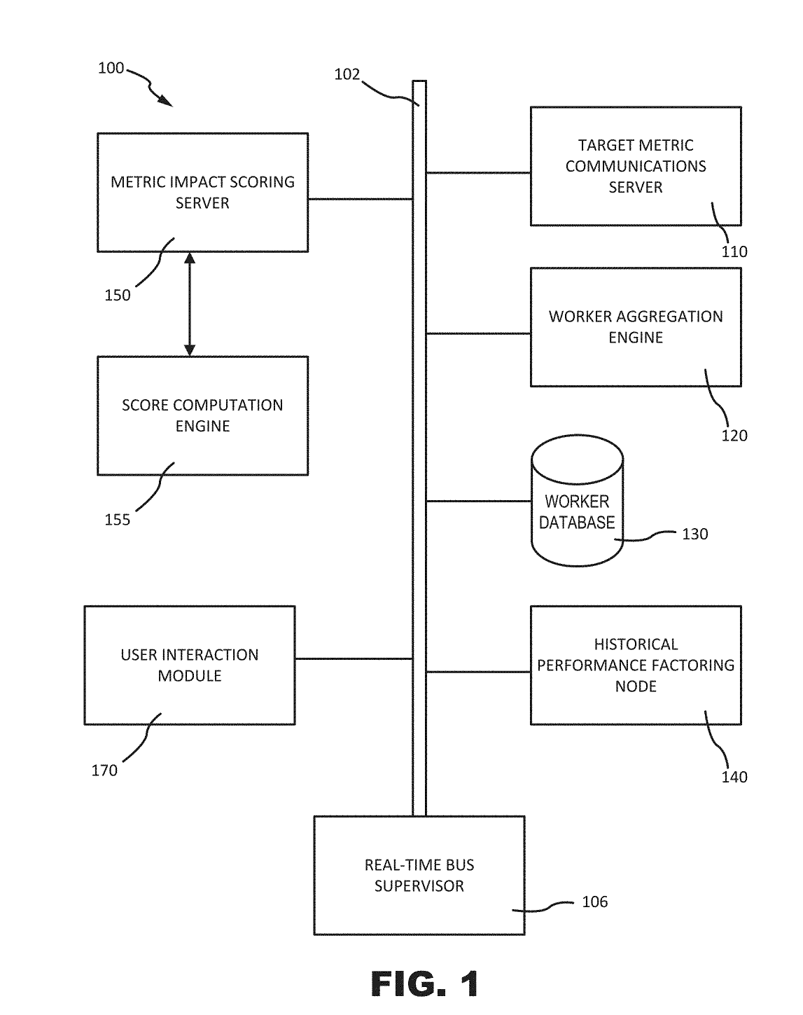

In various embodiments, and with reference to FIG. 1, a system 100 may comprise various engines, databases, and components with different roles. The various engines, databases and components may be in logical communication via a forecasting system bus 102. Forecasting system bus 102 may comprise a logical interconnection permitting communication amongst the engines, databases, and components. For example, forecasting system bus 102 may comprise a bus network arrangement wherein each engine, database, and component in communication with a main cable or link, enabling logical communication amongst each engine, database, and/or component. Forecasting system bus 102 may be in communication with a real-time bus supervisor 106 which may direct communication among the engines, databases, and components. Real-time bus supervisor 106 may comprise any suitable processor, controller, system, software, and/or apparatus, capable of directing communication among the engines, databases, and components of system 100. In various embodiments, the various engines, databases, and components of system 100 may also be in direct logical communication with each other, and/or be in logical communication with any individual and/or combination of engines, databases, and components.

More specifically, and in various embodiments, system 100 may comprise a target metric communications server 110, a worker aggregation engine 120, a worker database 130, a historical performance factoring node 140, a metric impact scoring server 150, a score computation engine 155, and/or a user interaction module 170.

In various embodiments, target metric communications server 110 may be configured to receive and transmit a target metric. Target metric communications server 110 may comprise any suitable type of server, engine, or component capable of receiving and sending data. Target metric communications server 110 may receive the target metric from any suitable source. For example, target metric communications server 110 may receive the target metric via a user input, such as through the use of a Tillable form on a website and/or the like. In this regard, the user may define the target metric that is desired to be forecasted through the construction project. The target metric may be determined by the system. For example, the system may automatically determine a target metric based on historical factor information, as discussed infra. The target metric may comprise any suitable type of data desired to be forecasted through a project. For example, the target metric may comprise data related to a construction project. In this regard, the target metric may comprise a time to completion, representative of the estimated amount of time remaining on the construction project. The target metric may also comprise cost to completion, representative of the estimated cost remaining to complete the project. The target metric may also comprise risk of default.

In various embodiments, worker aggregation engine 120 may be configured to aggregate data. Worker aggregation engine 120 may be configured to aggregate data related to individual workers from worker database 130. Worker aggregation engine 120 may comprise any suitable type of server, engine, and/or system component capable of sending, receiving, parsing, and/or aggregating data. In various embodiments, worker aggregation engine 120 may communicate with worker database 130, via forecasting system bus 102, to retrieve data for aggregation. Worker aggregation engine 120 may be instructed by real-time bus supervisor 106 to aggregate the data. In this regard, real-time bus supervisor 106 may also instruct worker aggregation engine 120 on what data may need to be retrieved from worker database 130. For example, worker aggregation engine 120 may be instructed to retrieve and aggregate all data related to a particular worker, subcontractor, or task in the construction project. As a further example, worker aggregation engine 120 may be instructed to retrieve all data related to the workers assigned to a particular task in the construction project, and aggregate the data by each individual worker. Worker aggregation engine 120 may retrieve data based on metadata, or by any other identifying characteristic. For example, each data set may comprise metadata regarding the particular subcontractor that the worker is employed for, the particular tasks the worker is assigned to, and/or the like. Worker aggregation engine 120 may then retrieve data on all of the workers for that subcontractor by only retrieving data comprising metadata for that subcontractor.

In various embodiments, worker database 130 may be configured to store and maintain data. Worker database 130 may comprise any suitable type of database or storage system capable of storing and maintaining data. Worker database 130 may store and maintain data using any suitable technique described herein and/or known in the art. Worker database 130 may be configured to store and maintain data relating to construction workers, such as, for example, those constructions workers staffed on a particular construction project. In this regard, worker database 130 may comprise a plurality of electronic records. Each electronic record may comprise a worker data set. The worker data set may correspond to a particular construction worker. The worker data set may comprise any suitable data relating to that construction worker. For example, the worker data set may comprise the worker's name, contact information (such as address, phone number, and/or the like), current licensing status, availability information, insurance information, credit information, and/or other such similar data.

In various embodiments, historical performance factoring node 140 may be configured to gather historical factor information corresponding to each worker on the project. Historical performance factoring node 140 may comprise any suitable type of server, engine, and/or system component capable of collecting and gathering information and data. Historical performance factoring node 140 may also be configured to gather the historical performance information and associate that historical factor information to each corresponding worker and/or the project.

In various embodiments, the historical factor information may comprise any suitable data about the corresponding worker and/or the project, relating to the target metric. Historical factor information may comprise information relating to similar projects, challenges with other projects, expected challenges with the project, time period/season for completing the project, the economic conditions when ordering materials, the available labor force during a time period, the availability of materials, and/or the like. The system may obtain such historical factor information from third party databases, social media websites, supply websites and other internet sources. The system may include a data feed, scrape websites, search databases or other methods for acquiring data.

In example embodiments, where the target metric may comprise cost to completion, the historical factor information may comprise the financial cost expended by the worker thus far, project schedule, project budget, project cost, status of project, an adjusted metric impact score, and/or the like. Where the target metric may comprise a risk of default, the historical factor information may comprise credit worthiness, licensing status, insurance status, an adjusted metric impact score, and/or the like. In various embodiments, the historical factor information may also comprise data regarding the target metric, the target metric impact score, and the metric forecast. In this regard, system 100 may provide a feedback loop wherein the data regarding the target metric, the target metric impact score, and the metric forecast becomes historical factor information after system 100 calculates it.

In various embodiments, historical performance factoring node 140 may also compile the historical factor information to create a performance score. In this regard, the performance score may be used as a rating system for an Interested Party. The performance score may comprise any suitable rating system, such as, for example, a numerical-based score from 1 to 10, wherein 1 represents a “low” score and 10 represents a “high” score. For example, where the Interested Party is a construction worker and the historical factor information relating to the construction worker comprises data detailing that the construction worker has a low credit score, has been late on projects, routinely goes over budget, and/or the like, the performance score may comprise a low score, such as a 1 or 2. The performance score may be transmitted or made available to other Interested Parties.

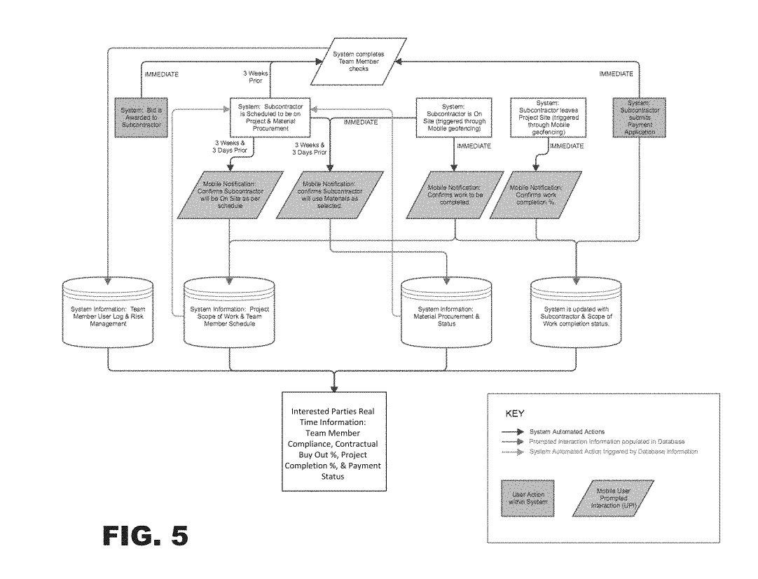

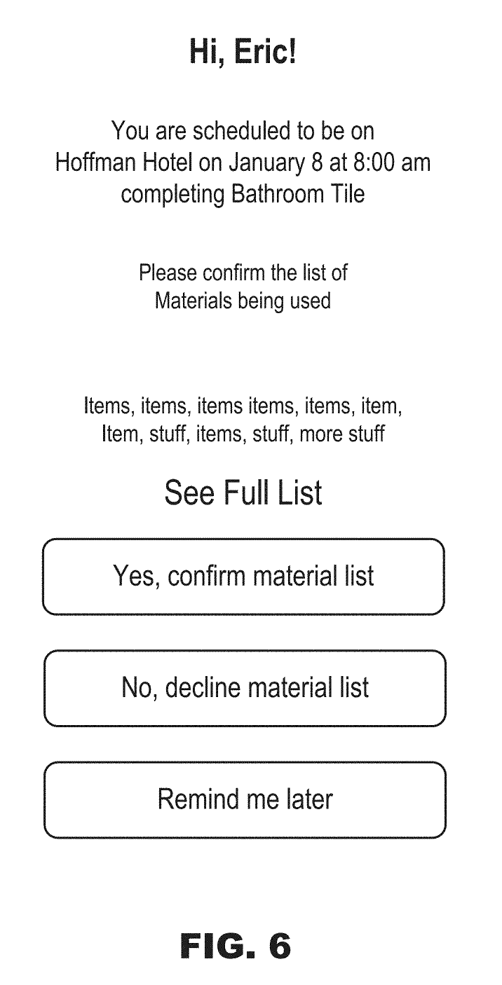

Historical performance factoring node 140 may gather the historical factor information from any suitable source. In various embodiments, historical performance factoring node 140 may gather the historical factor information from a user prompted interaction (“UPIs”). With reference to FIG. 5, a general flow chart detailing various UPIs is disclosed for better understanding. Historical performance factoring node 140 may be configured to operatively communicate with a user mobile device (or other such similar device) of a subcontractor, to transmit the UPI to the subcontractor. The UPI may comprise any suitable prompt related to the construction project. For example, and with reference to FIG. 6, the UPI may comprise a question related to the materials being used to complete a task. The UPI may prompt the subcontractor to confirm a list of materials being used to complete the task. The UPI may also prompt the subcontractor with any other suitable prompt, such as asking the status of the task that the worker is assigned to, the current completion percentage of that task, the current cost of that task (such as monetary amount expended), and/or the like.

In various embodiments, historical performance factoring node 140 may also gather the historical factor information based on geofencing. Geofencing is a concept known in the art, which may enable a party to set up triggers so that when a device enters (or exits) a geofencing boundary defined by the party, data can be tracked. In this regard, historical performance factoring node 140 may be configured to transmit the UPI to the subcontractor, or other suitable party, based on geofencing. For example, a geofencing boundary may be established around a one mile radius of a construction site for the construction project. Historical performance factoring node 140 may track the subcontractor's position within the geofencing boundary, based on GPS from the subcontractor's cellular phone, or through any other suitable means. Historical performance factoring node 140 may be configured to transmit the UPI to the subcontractor in response to the subcontractor traveling further than one mile, or any other desired distance, from the geofencing boundary (e.g., when the subcontractor is leaving for the day). The UPI in this example may prompt the subcontractor for an updated completion percentage of the task. Historical performance factoring node 140 may also be configured to transmit the UPI to the subcontractor in response to the subcontractor being within the geofencing boundary for longer than one hour, or any other desired duration of time. Historical performance factoring node 140 may also be configured to transmit the UPI to the subcontractor if a UPI has not been sent to the subcontractor in the previous four hours, or after any other desired duration.

In various embodiments, historical performance factoring node 140 may also gather the historical factor information from a networked resource, such as the Internet. In this regard, historical performance factoring node 140 may retrieve data corresponding to a subcontractor working on the construction project. For example, where the historical factor information may comprise licensing status, historical performance factoring node 140 may retrieve the historical factor information from a licensing authority, via a connection to the Internet. Where the historical factor information may comprise insurance status, historical performance factoring node 140 may retrieve the historical factor information from an insurance authority, via the Internet. As a further example, where the historical factor information may comprise credit worthiness, the historical performance factoring node 140 may retrieve the historical factor information from a credit reporting agency.

In various embodiments, metric impact scoring server 150 may be configured to receive, parse, and analyze data. Metric impact scoring server 150 may comprise any suitable server, engine, and/or system component capable of receiving, parsing, and/or analyzing data. In various embodiments, metric impact scoring server 150 may be configured to receive the target metric from target metric communications server 110. In this regard, real-time bus supervisor 106 may instruct target metric communications server 110 to transmit the target metric to metric impact scoring server 150, via forecasting system bus 102. Real-time bus supervisor 106 may transmit the instruction by sending a first exchange directive to target metric communications server 110, via forecasting system bus 102. The first exchange directive may comprise an instruction directing target metric communications server 110 to transmit the target metric.

In various embodiments, metric impact scoring server 150 may also be configured to receive the worker data set from worker aggregation engine 120. In this regard, real-time bus supervisor 106 may instruct worker aggregation engine 120 to transmit the worker data set to metric impact scoring server 150, via forecasting system bus 102. Real-time bus supervisor 106 may transmit the instruction by sending a second exchange directive to worker aggregation engine 120, via forecasting system bus 102. The second exchange directive may comprise an instruction directing worker aggregation engine 120 to transmit the worker data set.

In various embodiments, metric impact scoring server 150 may also be configured to receive the historical factor information from historical performance factoring node 140. In this regard, real-time bus supervisor 106 may instruct historical performance factoring node 140 to transmit the historical factor information to metric impact scoring server 150, via forecasting system bus 102. Real-time bus supervisor 106 may transmit the instruction by sending a third exchange directive to historical performance factoring node 140, via forecasting system bus 102. The third exchange directive may comprise an instruction directing historical performance factoring node 140 to transmit the historical factor information.

In various embodiments, the first exchange directive, the second exchange directive, and the third exchange directive may be sent by real-time bus supervisor 106 simultaneously and in real-time, or at any other suitable and/or desired interval of time.

In various embodiments, score computation engine 155 may be configured to assign a metric impact score to each of the plurality of workers and/or the project. Score computation engine 155 may be located within metric impact scoring server 150, for example, as a module or node in metric impact scoring server 150. In various embodiments, score computation engine 155 may also comprise a separate module, engine, and/or system component, configured to communicate with metric impact scoring server 150 via forecasting system bus 102. Score computation engine 155 may be configured to ingest the target metric, the worker data set, and the historical factor information, received via metric impact scoring server 150, and compute a resulting metric impact score. The metric impact score may therefore be based upon a computation of the target metric, the worker data set, and the historical factor information. The metric impact score may be computed by a 1 to 1 comparison, or based on a threshold. The metric impact score may comprise data determinative of a change in the target metric. For example, where the target metric may comprise time to completion, the metric impact score may comprise the amount of time that the time to completion has been either delayed or exceeded (e.g., two week delay, or two week exceedance). As a further example, where the target metric comprises insurance status, the metric impact score may comprise a change in the insurance status (e.g., a worker allowed his insurance to lapse). The metric impact score may therefore represent the impact that each of the plurality of workers is having on the target metric.

In various embodiments, metric impact scoring server 150 may also be configured to transmit a first adjustment instruction to target metric communications server 110. The first adjustment instruction may comprise an instruction to vary the target metric in response to the metric impact score. Metric impact scoring server 150 may transmit the first adjustment instruction via forecasting system bus 102. Target metric communications server 110 may ingest the first adjustment instruction, and, in response, generate a metric forecast. The metric forecast may comprise an “updated” target metric (e.g., the target metric varied by the metric impact score). Put another way, the metric forecast may represent the current value of the target metric at a given point in time. As an example, and in various embodiments, the target metric may comprise time to completion (e.g., four weeks, or a specific date), the historical factor information may comprise timeliness (such as how often the corresponding worker has been late to the worksite), and the metric impact score may comprise a delay of two weeks. Here, target metric communications server 110 may ingest the metric impact score and generate the metric forecast comprising a time to completion of an additional two weeks (e.g., six weeks, or the specific date plus two weeks). Target metric communications server 110 may also be configured to transmit the metric forecast to any suitable component of system 100, such as, for example, forecasting system bus 102.

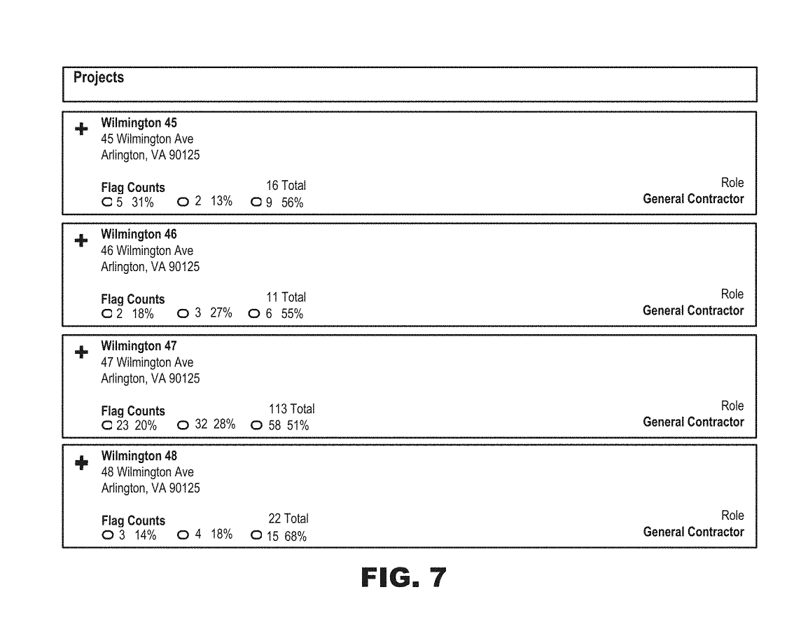

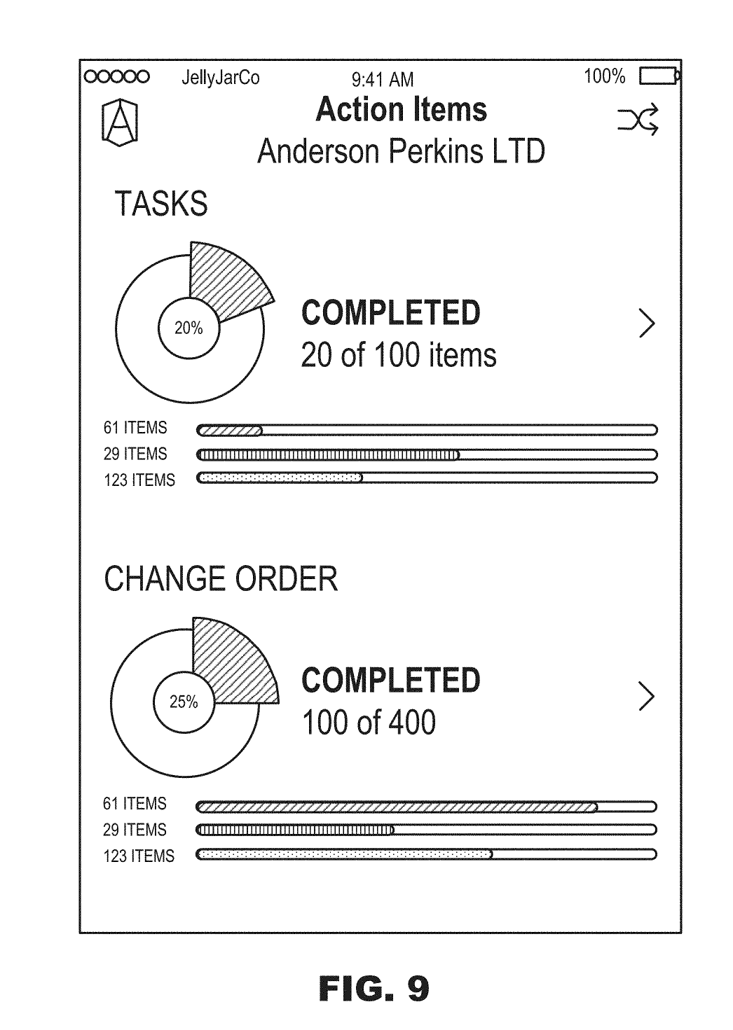

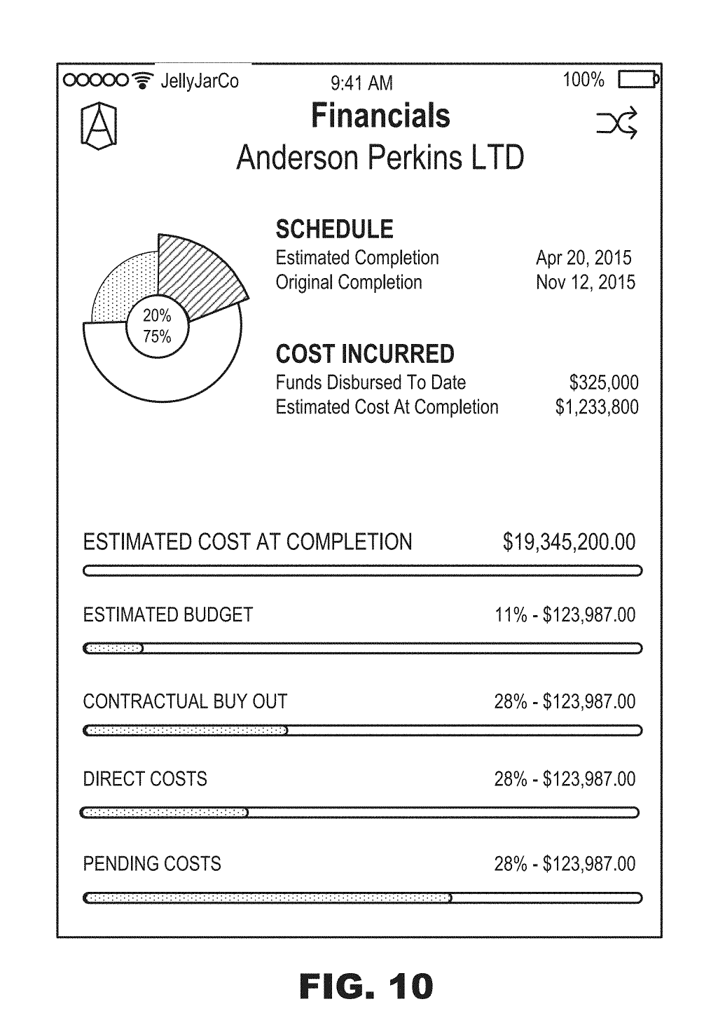

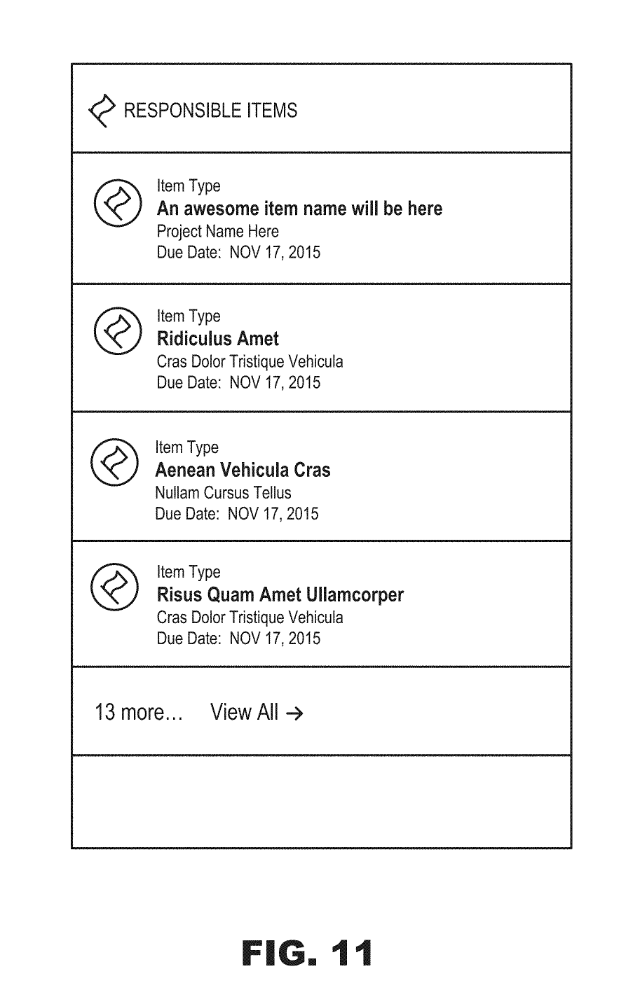

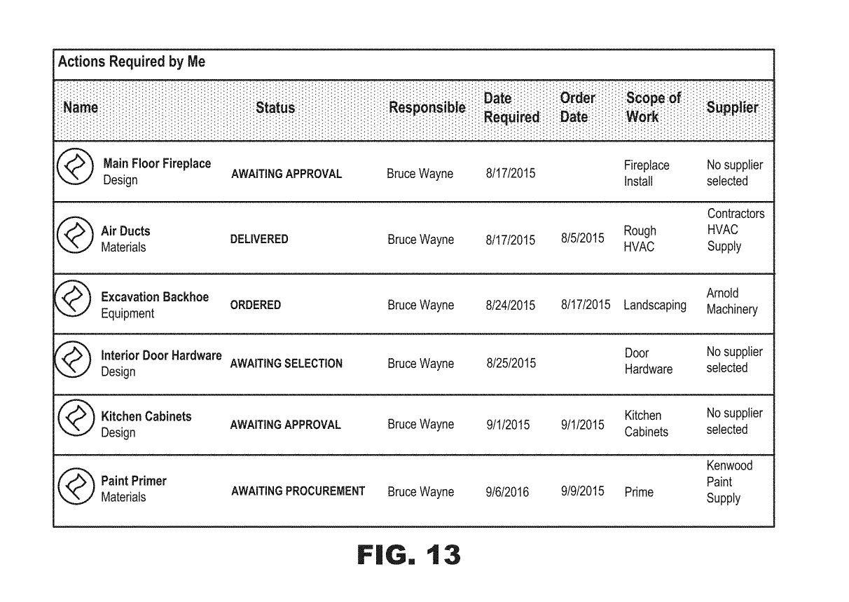

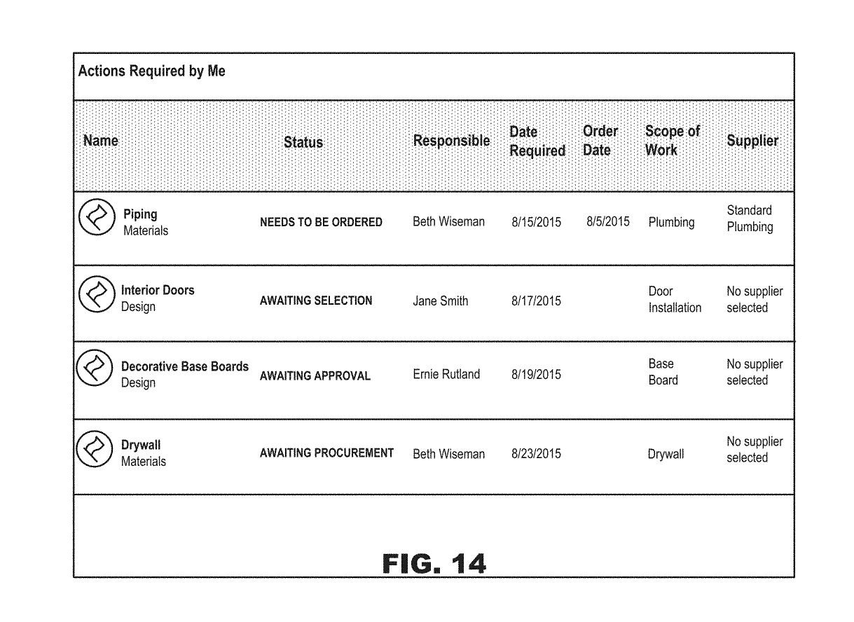

In various embodiments, user interaction module 170 may be configured to display visual information related to the construction project. For example, FIGS. 6-14 may provide exemplary examples of visual information that user interaction module 170 may be configured to display. User interaction module 170 may comprise any suitable device capable of displaying visual cues (or any other notification such as an audible sound, flashing icon, changing color, etc.). For example, user interaction module 170 may comprise any suitable type of LCD screen, smartphone, computer, touch-screen, and/or the like. User interaction module 170 may be configured to display visual cues related to a comparison of the target metric to the metric forecast. For example, in response to the metric forecast being equal to or less than the target metric, user interaction module 170 may display a first visual cue. For example, if the target metric comprised time to completion of 4 weeks, and the metric forecast comprised a time of completion of 3 weeks, user interaction module 170 may display the first visual cue. The first visual cue may be representative that the construction project is on pace for, or is under the originally forecasted metric (e.g., ahead of schedule). In response to the metric forecast being greater than the target metric, user interaction module 170 may display a second visual cue. For example, if the target metric comprised time to completion of 4 weeks, and the metric forecast comprised a time of completion of 5 weeks, user interaction module 170 may display the second visual cue. The second visual cue may therefore be representative that the construction project is currently exceeding the originally forecasted metric (e.g., behind schedule).

In various embodiments, user interaction module 170 may also be configured to display a guidance and/or a remedial action based on the metric impact score. User interaction module 170 may display the guidance and/or the remedial action along with the visual cue, or separate from the visual cues. The guidance and/or the remedial action may comprise techniques, information, and/or the like to reduce the metric impact score (i.e., to lower the metric forecast to be closer to the target metric). For example, the guidance may comprise credit repair techniques, such as websites, information, and/or the like on how to improve and/or fix a credit score. For example, the remedial action may comprise skipping and/or redefining project steps in order to prioritize other aspects of the project requiring completion (e.g., replacing one finish with another, more readily available finish). In various embodiments, system 100, via target metric communications server 110, may also be configured to transmit the guidance and/or the remedial action to the Interested Party via an e-mail message, text message, and/or the like.

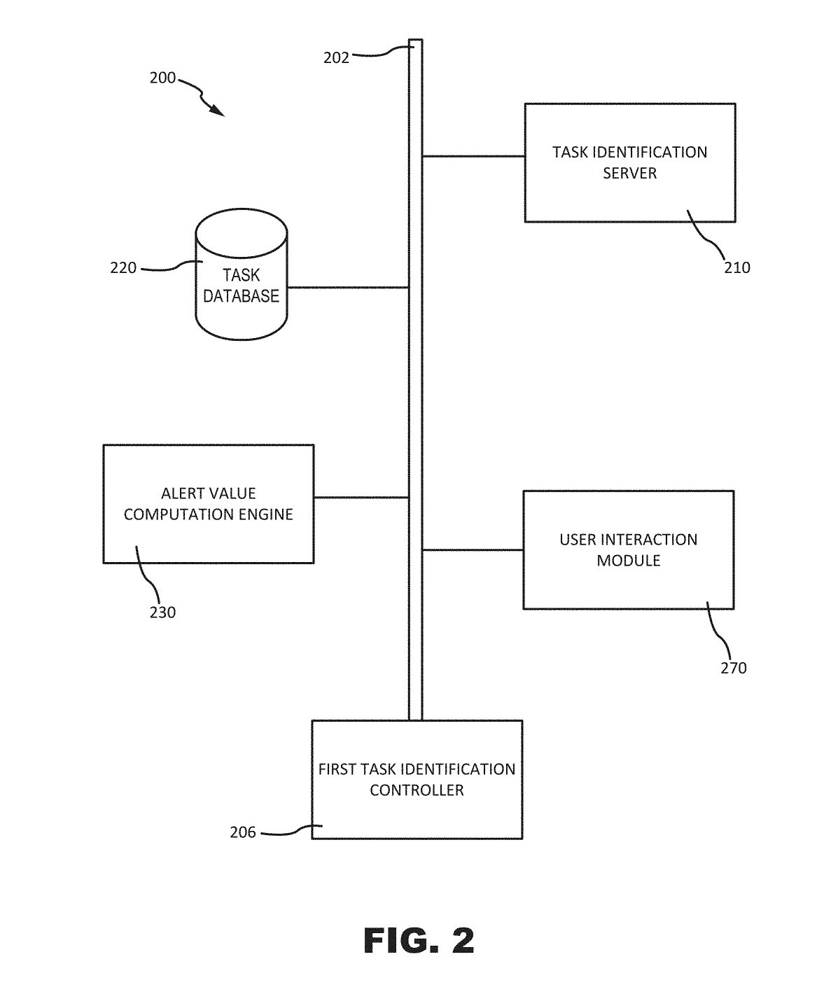

In various embodiments, and with reference to FIG. 2, a system 200 may comprise various engines, databases, and components with different roles. The various engines, databases and components may be in logical communication via a first task identification bus 202. First task identification bus 202 may comprise a logical interconnection permitting communication amongst the engines, databases, and components. For example, first task identification bus 202 may comprise a bus network arrangement wherein each engine, database, and component in communication with a main cable or link, enabling logical communication amongst each engine, database, and component. First task identification bus 202 may be logically connected to a first task identification controller 206 which may direct communication among the engines, databases, and components. First task identification controller 206 may comprise any suitable processor, controller, system, software, and/or apparatus, capable of directing communication among the engines, databases, and components of system 200. In various embodiments, the various engines, databases, and components of system 200 may also be in direct logical communication with each other, and/or be in logical communication with any individual and/or combination of engines, databases, and components.

More specifically, and in various embodiments, system 200 may comprise a task identification server 210, a task database 220, an alert value computation engine 230, and/or a user interaction module 270. In various embodiments, task identification server 210 may be configured to retrieve data from task database 220, via first task identification bus 202. Task identification server 210 may comprise any suitable server, engine, and/or component capable of retrieving data. Task identification server 210 may retrieve a library of defined tasks from task database 220. Task identification server 210 may be instructed, by first task identification controller 206 to identify a first task from the library of defined tasks. Task identification server 210 may identify any suitable and/or desired task from the library of defined tasks. In various embodiments, the tasks located in library of defined tasks may have a defined priority and/or ranking. In that regard, the first task may therefore comprise the task having the highest priority and/or ranking. For example, tasks that may have dependent or multiple-dependent successor tasks, or have a high impact on finance or schedule, may be given a high priority. Conversely, tasks that may not have any dependent successor tasks, and may have a low impact on the construction project, may be given a low priority. Task identification server 210 may also be configured to transmit the first task to any suitable system 200 engine or component. For example, task identification server 210 may transmit the first task to first task identification bus 202, alert value computation engine 230, and/or user interaction module 270.

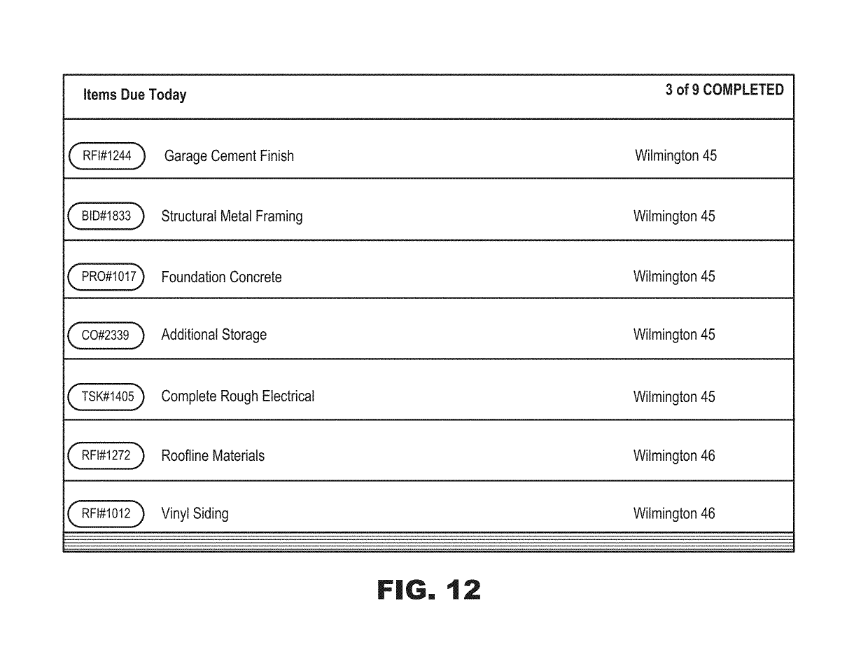

In various embodiments, task database 220 may be configured to store and maintain data. Task database 220 may comprise any suitable type of database or storage platform capable of storing and maintaining data. Task database 220 may store and maintain data using any suitable technique described herein and/or known in the art. Task database 220 may be configured to store and maintain data relating to tasks for a particular construction project. In this regard, task database 220 may store the tasks in a library of defined tasks. The plurality of tasks may be input, or may also be automatically recognized and entered by system 200. Each task may comprise a subset of data, such as, the completion date, the budget cost, the workers assigned to the task, the scope of the work, the supplied, and/or the like. For example, the construction project manager, owner, and/or the like may input and define tasks, and assign the tasks to various schedule phases and sub-phases, financial divisions and cost codes, and/or the like. In this regard, the inputting of tasks may define the scope of work throughout the construction project lifecycle. System 200 may therefore enable the assigning of financial, team, task, and schedule resources to one central evaluation point, through the use of various tasks. This setup may enable system 200 to project out the velocity and cash flow requirements of the construction project. The library of defined tasks may comprise any task related to the construction project. For example, and with reference to FIGS. 12, 13, and 14, a task may comprise piping, designing kitchen cabinets, completing rough electrical, and/or any other suitable task related to the construction project.

In various embodiments, the plurality of tasks in the library of defined tasks may each comprise metadata, or any other similar type of data marker, defining the dependency of the tasks. For example, the metadata may comprise data indicating those tasks that must be completed prior to the beginning of the task. The metadata may also comprise data indicating those tasks that are dependent on the task (i.e., the tasks that cannot begin until the task is completed). In this regard, each task may comprise any number of precedent and successor tasks. For example, a task may comprise a first successor task. The first successor task may also comprise a second successor task (i.e., the task has two dependent tasks). As a further example, where the task may comprise drywall, a successor task may comprise decorative base boards, paint primer, and/or the like.

In various embodiments, alert value computation engine 230 may be configured to assign an alert value to a task. Alert value computation engine 230 may comprise any suitable engine, server, and/or the like capable of receiving, parsing, analyzing, and/or transmitting data. Alert value computation engine 230 may be configured to receive the first task from task identification server 210, via first task identification bus 202. Alert value computation engine 230 may be instructed by first task identification controller 206 to assign the alert value to the first task. The alert value may represent an alert utilized to guide the construction project to tasks that could deter the project from its critical path. In this regard, the alert value may comprise a low alert, a medium alert, or a high alert. Alert value computation engine 230 may assign the alert value to the first task by analyzing the first task to determine the effects a failure or delay in the task would affect schedule, budgeted cost, and other such factors. In this regard, alert value computation engine 230 may retrieve the first task, and analyze the subset data of the first task to determine whether the task is still on schedule, budget, etc. For example, if the first task comprised a scheduled completion data two days from the current date, and the first task is currently at 25% completed, alert value computation engine 230 may assign the alert value of a low alert to schedule. As a further example, if the first task comprised a budget of $1000, and the first task was currently at 25% completed and a cost of $999, alert value computation engine 230 may assign the alert value of a low alert to budget.

In various embodiments, alert value computation engine 230 may also be configured to compare the alert value to an alert condition. Alert value computation engine 230 may be instructed by first task identification controller 206 to compare the alert value to the alert condition. In various embodiments, in response to the comparison, alert value computation engine 230 may instruct user interaction module 270 to display a visual cue. The alert condition may comprise any suitable condition within the construction project that may cause deterrence if there was a delay. For example, the alert condition may comprise schedule (e.g., a date the task is to be completed), budget (e.g., the monetary cost estimated for the task), a first capitalization ratio comprising a subcontractor liquidity estimate, and/or the like. Alert value computation engine 230 may compare whether the first task has an alert value assigned to the same condition as the alert condition. For example, where the first task may have an alert value of a low alert to schedule, and the alert condition is schedule, alert value computation engine may instruct user interaction module 270 to display the first visual cue. However, where the first task may have an alert value of a low alert to schedule, and the alert condition is budget, alert value computation engine may continue analyzing the data, and not instruct user interaction module 270 to do anything.

In various embodiments, alert value computation engine 230 may also be configured to adjust the alert value in response to the first task having successor tasks. For example, in response to the first task having a first successor task dependent upon the first task, alert value computation engine 230 may adjust the alert value by a first factor. Alert value computation engine 230 may then direct user interaction module 270 to adjust the first visual cue in a first way. In response to the first successor task having a second successor task dependent upon the first successor task, alert value computation engine 230 may adjust the alert value by a second factor. Alert value computation engine 230 may then direct user interaction module 270 to adjust the first visual cue in a second way.

In various embodiments, user interaction module 270 may be configured to display visual cues. User interaction module 270 may comprise any suitable device capable of displaying visual cues. For example, user interaction module 270 may comprise any suitable type of LCD screen, smartphone, computer, touch-panel, and/or the like. As discussed herein, user interaction module 270 may be configured to display the first visual cue in response to the alert condition not being met. The first visual cue may comprise a visual alert. For example, the first visual cue may comprise a flag alert, or any suitable symbol or design, having any suitable color, indicating that the first task has an alert on it. For example, in response to the alert value not meeting the alert condition, user interaction module 270 may display a first visual cue having a “green” color, or any suitable color, indicating a low level warning on the first task.

In various embodiments, user interaction module 270 may also be configured to adjust the first visual cue in response to the first task having successor tasks. User interaction module 270 may be configured to display a different visual cue in response to the first task having successor tasks. For example, in response to the alert value not meeting the alert condition, user interaction module 270 may display a first visual cue. In response to the first task having a first successor task dependent upon the first task, user interaction module 270 may adjust the first visual cue in a first way. In response to the first successor task having a second successor task dependent upon the first successor task, user interaction module 270 may adjust the first visual cue in a second way. As a further example, tasks that do not have any dependent tasks, but do not meet the alert condition, may have a low impact on the rest of the construction project, and user interaction module 270 may display the first visual cue comprising a low warning (such as a “green” colored warning). Tasks that may only have one dependent task may have a medium impact on the rest of the construction project, and user interaction module 270 may adjust the first visual cue in a first way, displaying the first visual cue comprising a medium warning (such as a “yellow” colored warning). Tasks that have multiple dependent tasks may have a high impact on the rest of the construction project, and user interaction module 270 may therefore adjust the first visual cue in a second way, displaying the first visual cue comprising a high warning (such as a “red” colored warning). User interaction module 270 may adjust the first visual cue in any suitable manner to indicate that there has been a change in the alert level of the first task.

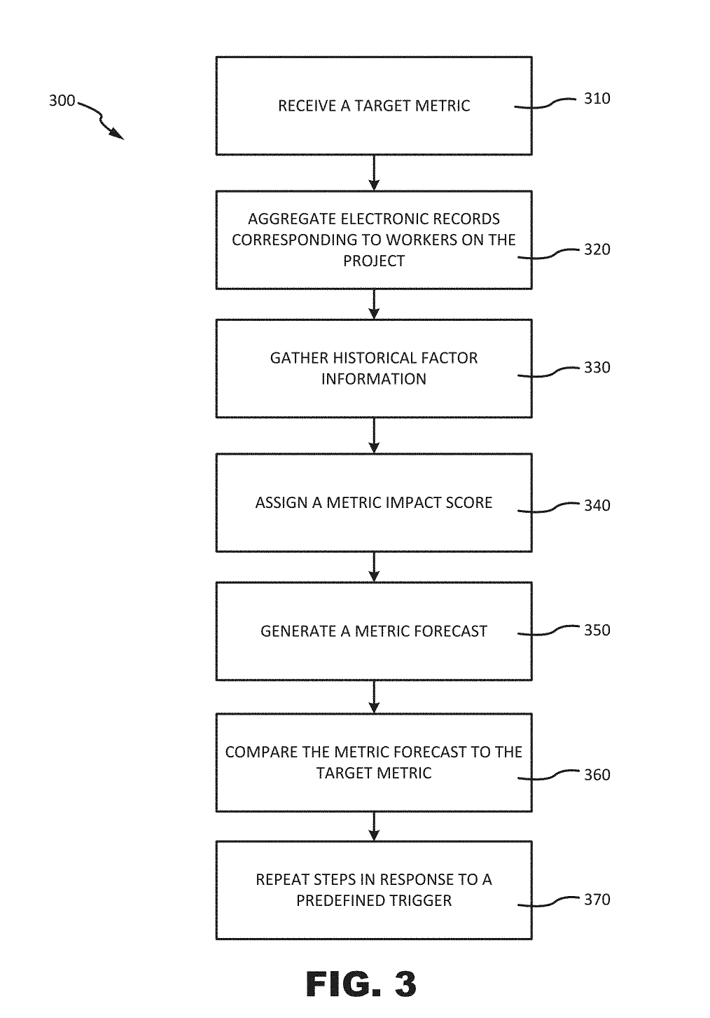

In various embodiments, and with reference to FIG. 1 and FIG. 3, a method 300 of forecasting a metric through completion of a project is disclosed. Method 300 may be used to identify and trigger risk assessment checks on project team members during predefined times within the lifecycle (or before and after the lifetime) of the construction project. Method 300 may identify and trigger risk assessment checks to ensure that the construction project is not put at risk. In this regard, method 300 may provide a mechanism for automated project team member compliance verification by reviewing and analyzing target metrics related to project team members (e.g., instantly and/or in real time).

Method 300 may be used to automate the draw process to enable a centralized means of payment distribution to the Interested Parties. In this regard, method 300 may incorporate a banking system, accounts receivable system, and/or the like to automate the draw process. Each Interested Party may have a separate virtual transaction account (which may or may not include a physical transaction card such as a debit card, ATM card, credit card, and/or the like), and, during the draw process, payment may be distributed to the correct Interested Party's virtual transaction account. By automating the draw process and enabling a centralized means of payment distribution, method 300 may provide greater transparency of the draw process to all Interested Parties while also preventing co-mingling of payment funds for an Interested Party (e.g., an Interested Party may be involved in multiple projects, and, over the course of work, the payments from the various projects become mixed together). Greater transparency of the draw process may also ensure that various Interested Parties provide correct and timely payments to other Interested Parties in the project (e.g., the greater transparency may help ensure that an owner provides payment to a contractor, and that the contractor provides payment to the various sub-contractors).

Method 300 may also be used to automate the draw process to comprise a more robust risk assessment. For example, if the target metric comprises a worker and/or subcontractor's credit, and the metric forecast comes back that the credit is below the limit that may be required, method 300 may enable an Interested Party to recognize that the credit is below the limit before the draw process. That Interested Party may then be able to request that the worker and/or subcontractor provide a proof of payment, or receive a separate payment directly. Moreover, method 300 may also enable an Interested Party to view historical factor information, and data regarding the target metric, the target metric impact score, and the metric forecast, to determine whether to give a worker a money loan or an advance payment.

In various embodiments, method 300 may comprise receiving a target metric (step 310). The target metric may be received by target metric communications server 110. The target metric may be input by a user, at any point in time during the lifecycle of the construction project. The target metric may also be automatically assigned by system 100. For example, the target metric forecasted by system 100 may comprise the same target metric for every construction project. The target metric may also be selected prior to the start of the construction project. Target metric communications server 110 may be configured to transmit the target metric. For example, target metric communications server 110 may transmit the target metric to forecasting system bus 102, worker aggregation engine 120, and/or any other suitable system 100 component.

In various embodiments, method 300 may comprise aggregating electronic records corresponding to workers on the project (step 320). Worker aggregation engine 120 may be configured to aggregate the electronic records corresponding to workers on the project. In this regard, worker aggregation engine 120 may retrieve the electronic records from worker database 130. The electronic records may each comprise a worker data set corresponding to a worker who works on the project. Worker aggregation engine 120 may therefore aggregate the plurality of electronic records, and gather the worker data sets corresponding to the plurality of workers on the project. Worker aggregation engine 120 may be configured to transmit the plurality of electronic records, including the plurality of worker data sets, to any suitable system 100 component, such as to forecasting system bus 102, historical performance factoring node 140, and/or metric impact scoring server 150.

In various embodiments, method 300 may comprise gathering historical factor information (step 330). Historical performance factoring node 140 may be configured to gather the historical factor information. The historical factor information may correspond to each worker on the project. Historical performance factoring node 140 may also be configured to associate the historical factor information with the corresponding worker data set. In this regard, each worker on the project may therefore have a corresponding worker data set and corresponding historical factor information. Historical performance factoring node 140 may gather the historical factor information from any suitable source, such as, for example, through the Cloud. Historical performance factoring node 140 may transmit the historical factor information to any suitable location, such as to forecasting system bus 102.

In various embodiments, method 300 may comprise assigning a metric impact score (step 340). The metric impact score may be assigned by metric impact scoring server 150. Metric impact scoring server 150 may assign the metric impact score to each of the plurality of workers. The metric impact score may be calculated based on the target metric, the worker data set, and the historical factor information.

In various embodiments, step 340 may comprise metric impact scoring server 150 receiving the target metric. Metric impact scoring server 150 may receive the target metric from target metric communications server 110, via forecasting system bus 102. In this regard, real-time bus supervisor 106 may be configured to instruct target metric communications server 110 to transmit the target metric to metric impact scoring server 150. Real-time bus supervisor 106 may instruct target metric communications server 110 by sending a first exchange directive, via forecasting system bus 102. In response to receiving the first exchange directive, target metric communications server 110 may then transmit the target metric, via forecasting system bus 102, to metric impact scoring server 150.

In various embodiments, step 340 may also comprise metric impact scoring server 150 receiving the worker data set. Metric impact scoring server 150 may receive the worker data set from worker aggregation engine 120, via forecasting system bus 102. In this regard, real-time bus supervisor 106 may be configured to instruct worker aggregation engine 120 to transmit the worker data set to metric impact scoring server 150. Real-time bus supervisor 106 may instruct worker aggregation engine 120 by sending a second exchange directive, via forecasting system bus 102. In response to receiving the second exchange directive, worker aggregation engine 120 may then transmit the worker data set, via forecasting system bus 102, to metric impact scoring server 150.

In various embodiments, step 340 may also comprise metric impact scoring server 150 receiving the historical factor information. Metric impact scoring server 150 may receive the historical factor information from historical performance factoring node 140, via forecasting system bus 102. In this regard, real-time bus supervisor 106 may be configured to instruct historical performance factoring node 140 to transmit the historical factor information to metric impact scoring server 150. Real-time bus supervisor 106 may instruct historical performance factoring node 140 by sending a third exchange directive, via forecasting system bus 102. In response to receiving the third exchange directive, historical performance factoring node 140 may then transmit the historical factor information, via forecasting system bus 102, to metric impact scoring server 150.

In various embodiments, real-time bus supervisor 106 may be configured to transmit the first exchange directive, second exchange directive, and/or third exchange directive at the same time, at similar times, and/or in any suitable order.

In various embodiments, step 340 may further comprise calculating a score computation and assigning the metric impact score. The metric impact score may be calculated by metric impact scoring server 150 via score computation engine 155. In this regard, score computation engine 155 may be configured to ingest the target metric, the worker data set, and the historical factor information to calculate the score computation corresponding to each of the plurality of workers. The metric impact score may be calculated through a 1 to 1 comparison, a threshold, and/or through any other suitable method. Metric impact scoring server 150 may retrieve the score computation from score computation engine 155 and assign the metric impact score to the corresponding worker, based on the score computation.

In various embodiments, method 300 may comprise generating a metric forecast (step 350). Metric impact scoring server 150 may direct target metric communications server 110 to vary the target metric in response to the metric impact score. Metric impact scoring server 150 may direct target metric communications server 110 by transmitting a first adjustment instruction, via forecasting system bus 102. The first adjustment instruction may comprise a directive to vary the target metric in response to the metric impact score.

In various embodiments, step 350 may comprise target metric communications server 110 ingesting the first adjustment instruction and, in response, generating the metric forecast. The metric forecast may represent an “updated” target metric. In this regard, the metric impact score may alter the target metric to generate an updated target metric, e.g., what the target metric may now be at a given point in time. As an example, and in various embodiments, the target metric may comprise time to completion (such as four weeks, or a specific date), the historical factor information may comprise timeliness (such as how often the corresponding worker has been late on similar projects), and the metric impact score may comprise a delay of two weeks. Here, target metric communications server 110 may therefore ingest the metric impact score and generate the metric forecast comprising a time to completion of an additional two weeks. The metric forecast may be sent by target metric communications server 100 to any suitable system 100 component, such as forecasting system bus 102.

In various embodiments, method 300 may comprise comparing the metric forecast to the target metric (step 360). User interaction module 170 may be configured to retrieve the metric forecast and the target metric from any suitable system 100 component, such as forecasting system bus 102. User interaction module 170 may compare the target metric to the metric forecast. User interaction module 170 may make the comparison through a one-to-one comparison, or through the use of an algorithm and/or any other suitable comparison method. In response to the metric forecast being equal to or less than the target metric, user interaction module 170 may display a first visual cue. The first visual cue may represent that the construction project is either on pace for, or below the target metric (e.g., the time to completion at the current stage of the project is less than the estimated time to completion at the beginning of the project). In response to the metric forecast being greater than the target metric, user interaction module 170 may display a second visual cue. The second visual cue may be distinguishable from the first visual cue. The second visual cue may represent that the construction project is above the target metric (e.g., the time to completion at the current stage of the project is greater than the estimated time to completion at the beginning of the project).

In various embodiments, method 300 may comprise repeating step 310 through step 360 in response to a predefined trigger (step 370). Step 370 may repeat step 310 through step 360 throughout the lifecycle of the construction project. Real-time bus supervisor 106 may be configured to direct target metric communications server 110, worker aggregation engine 120, historical performance factoring node 140, metric impact scoring server 150, and score computation engine 155 to repeat the above mentioned steps. Real-time bus supervisor 106 may direct the various engines and components via forecasting system bus 102. Real-time bus supervisor 106 may be configured to direct the various engines and components in response to the predefined trigger. The predefined trigger causing the steps to repeat may comprise any suitable event in the construction project lifecycle. For example, the predefined trigger may comprise a point when a new subcontractor is contracted onto the construction project, or at a point prior to the subcontractor being scheduled on the project (such as a week prior to the subcontractor's start date). The predefined trigger may also comprise a point prior to a draw payment being made to the subcontractor. The predefined trigger may also comprise any suitable point, such as a point in time the general contractor and/or owner schedules a compliance check.

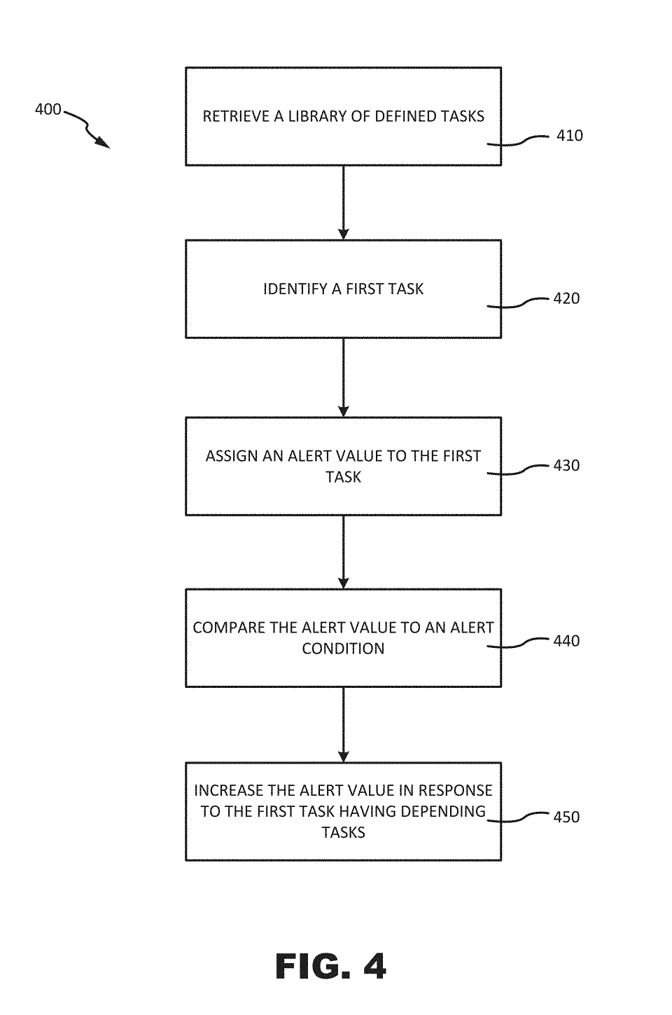

In various embodiments, and with reference to FIG. 2 and FIG. 4, a method 400 of guiding a project is disclosed. Method 400 may be used to identify tasks within the construction project that may deter the project from its critical path if the task was delayed or failed. The tasks may be assigned various alert values, depending on the importance of the task to the construction project. Method 400 may also be used to quantify in real time the potential financial and scheduling impact of each task. Method 400 may prioritize and rank the tasks from those with the highest level of financial and schedule impact, to those of the least level of financial and schedule impact.

In various embodiments, method 400 may comprise retrieving a library of defined tasks (step 410). Task identification server 210 may be configured to retrieve the library of defined tasks from task database 220, via first task identification bus 202.

In various embodiments, method 400 may comprise identifying a first task (step 420). Task identification server 210 may be instructed to identify the first task from task database 220. In this regard, first task identification controller 206 may instruct task identification server 210, via first task identification bus 202, to identify the first task. The first task may comprise any suitable or desired task from task database 220, such as, for example, a task that could deter the construction project from its critical path if the task was delayed and/or failed. Task identification server 210 may identify the first task using any suitable method, such as, for example, by identifying the task that was previously ranked and/or prioritized as the first task, and/or through metadata attached to the first task. Task identification server 210 may be configured to transmit the first task to any suitable system 200 component. For example, task identification server 210 may transmit the first task to first task identification bus 202, alert value computation engine 230, and/or any other suitable system 200 component.

In various embodiments, method 400 may comprise assigning an alert value to the first task (step 430). Alert value computation engine 230 may be configured to assign the alert value to the first task. In this regard, first task identification controller 206 may be configured to instruct alert value computation engine 230, via first task identification bus 202, to assign the alert value to the first task. The alert value may represent an alert utilized to guide the construction project to tasks that could deter the project from its critical path. In this regard, the alert value may comprise a low alert, a medium alert, or a high alert. Alert value computation engine 230 may assign the alert value to the first task by analyzing the first task to determine the effects a failure or delay in the task would affect schedule, budgeted cost, and other such factors.

In various embodiments, method 400 may comprise comparing the alert value to an alert condition (step 440). Alert value computation engine 230 may compare the alert value to the alert condition. In this regard, first task identification controller 206 may be configured to instruct alert value computation engine 230, via first task identification bus 202, to compare the alert value to the alert condition. The alert condition may comprise any suitable condition within the construction project that may cause deterrence if there was a delay. For example, the alert condition may comprise a schedule (e.g., a date the task is to be completed), budget (e.g., the monetary cost estimated for the task), a first capitalization ratio comprising a subcontractor liquidity estimate, and/or the like. Alert value computation engine 230 may compare whether the first task has an alert value assigned to the same condition as the alert condition. For example, where the first task may have an alert value of a low alert to schedule, and the alert condition is schedule, alert value computation engine may instruct user interaction module 270 to display the first visual cue. However, where the first task may have an alert value of a low alert to schedule, and the alert condition is budget, alert value computation engine may continue analyzing the data, and not instruct user interaction module 270 to do anything.

In various embodiments, step 440 may further comprise user interaction module 270 displaying a first visual cue, in response to the alert condition not being met. First task identification controller may logically instruct user interaction module 270, via first task identification bus 202, to display the first visual cue. User interaction module 270 may display the first visual cue simultaneously, and in real time, as alert value computation engine compares the alert value to the alert condition. User interaction module 270 may also display the first visual cue at a predetermined time interval after the comparison is made, or at any other suitable time.

In various embodiments, method 400 may comprise increasing the alert value in response to the first task having dependent tasks (step 450). Alert value computation engine 230 may be configured to increase the alert value. Alert value computation engine 230 may increase the alert value in response to the comparison performed in step 440. Alert value computation engine 230 may increase the alert value by a first factor in response to the first task having a first successor task dependent upon the first task. Alert value computation engine 230 may also increase the alert value by a second factor in response to the first successor task having a second successor task.

In various embodiments, user interaction module 270 may be configured to adjust the first visual cue simultaneously (or at any suitable time interval) with the increase of the alert value in step 450. User interaction module 270 may adjust the first visual cue in a first way in response to the first task having a first successor task dependent upon the first task. User interaction module 270 may adjust the first visual cue in a second way in response to the first successor task having a second successor task dependent upon the first successor task. The second way may be distinguishable from the first way.

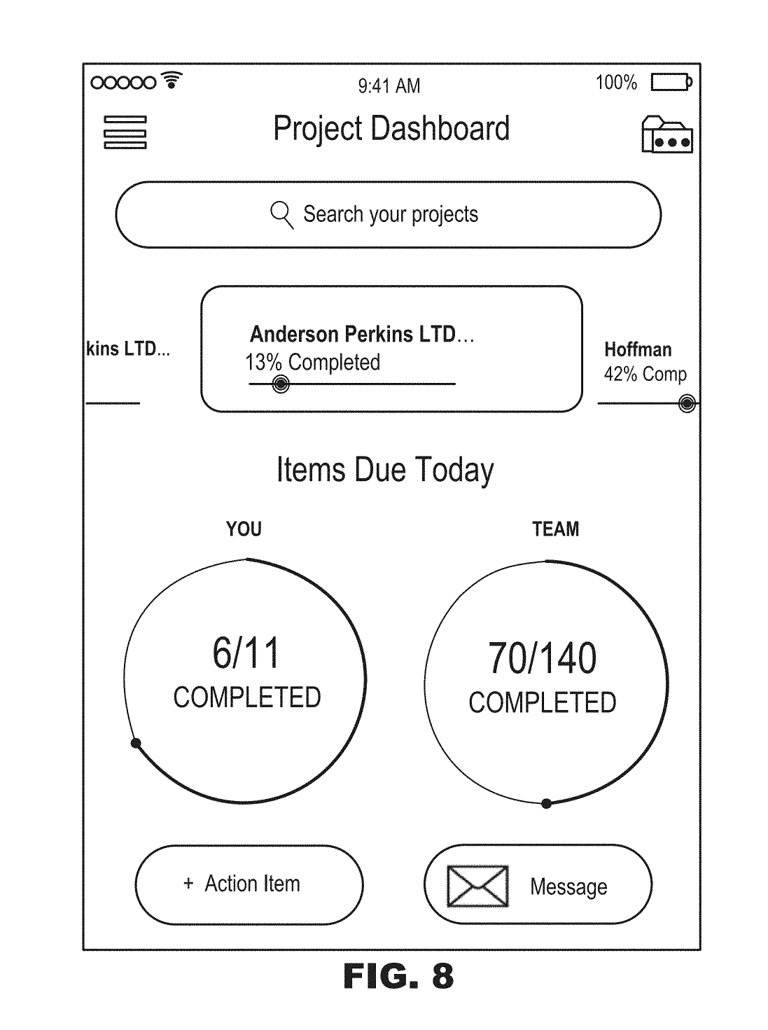

In various embodiments, step 450 may therefore comprise a mechanism to quantify the potential financial and schedule impact of each task, and rank the tasks with an alert value from those with the highest level of financial and schedule impact, to those of the least level of financial and schedule impact, based on the quantification. FIGS. 8, 9 and 10 are disclosed for reference, may be referenced as further examples and depictions of method 400. For example, tasks that do not have any dependent tasks may have a low impact on the rest of the construction project, and user interaction module 270 may display the first visual cue comprising a low warning (such as a “green” colored warning). Tasks that may only have one dependent task may have a medium impact on the rest of the construction project, and user interaction module 270 may adjust the first visual cue in a first way, displaying the first visual cue comprising a medium warning (such as a “yellow” colored warning). Tasks that have multiple dependent tasks may have a high impact on the rest of the construction project, and user interaction module 270 may therefore adjust the first visual cue in a second way, displaying the first visual cue comprising a high warning (such as a “red” colored warning). FIGS. 8, 9 and 10 are disclosed for reference, may be referenced as further examples and depictions of method 400.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

As used herein, big data may refer to partially or fully structured, semi-structured, or unstructured data sets including millions of rows and hundreds of thousands of columns. A big data set may be compiled, for example, from a history of risks assessments, such as credit, judgment, insurance, background, and/or licensing, from prior historical factor information, from prior worker data, from social media, from internal data, and/or from any other suitable sources. Big data sets may be compiled without descriptive metadata such as column types, counts, percentiles, or other interpretive-aid data points.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a contractor website, a social media website, affiliate or partner websites, an external vendor, a mobile device communication, social media network and/or location based service. Distribution channels may include at least one of a contractor website, a social media site, affiliate or partner websites, an external vendor, and a mobile device communication. Examples of social media sites include FACEBOOK®, FOURSQUARE®, TWITTER®, MYSPACE®, LINKEDIN®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor in communication with a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® /CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 and system 200 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® Applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a method of communication, such as the internet. Web services are typically based on standards or protocols such as XML, SOAP, AJAX, WSDL and UDDI. Web services methods are well known in the art, and are covered in many standard texts.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, popup window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. Cryptography and network security methods are well known in the art, and are covered in many standard texts.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101. Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of forecasting a target metric, comprising:
receiving, by a target metric communications server, the target metric for a project;
transmitting, by the target metric communications server, the target metric to a worker aggregation engine;
aggregating, by the worker aggregation engine, a plurality of electronic records from a worker database, each of the plurality of electronic records comprising a worker data set and corresponding to a plurality of workers who work on the project;
gathering, by a historical performance factoring node, a historical factor information corresponding to each worker and associating the historical factor information with the worker data set;
receiving, by a metric impact scoring server, the target metric from the target metric communications server, via a forecasting system bus, in response to a first exchange directive from a real-time bus supervisor,
receiving, by the metric impact scoring server, the worker data set from the worker aggregation engine, via the forecasting system bus, in response to a second exchange directive from the real-time bus supervisor;
receiving, by the metric impact scoring server, the historical factor information from the historical performance factoring node, via the forecasting system bus, in response to a third exchange directive from the real-time bus supervisor;
assigning, by the metric impact scoring server, each of the plurality of workers a metric impact score based on a score computation engine configured to ingest the target metric, the worker data set, and the historical factor information;
transmitting, on the forecasting system bus, a first adjustment instruction from the metric impact scoring server to the target metric communications server, the first adjustment instruction comprising a directive to vary the target metric in response to the metric impact score, whereby the metric impact scoring server ingests the first adjustment instruction and in response transmits a metric forecast to the forecasting system bus;
retrieving, by an user interaction module, the metric forecast from the forecasting system bus;
displaying, by the user interaction module, a first visual cue in response to the metric forecast being equal to or less than the target metric;
displaying, by the user interaction module, a second visual cue distinguishable from the first visual cue, in response to the metric forecast being greater than the target metric; and
directing, by the real-time bus supervisor, the target metric communications server, the worker aggregation engine, the historical performance factoring node, and the metric impact scoring server, to repeat the abovementioned steps in response to a plurality of predefined triggers.

2. The method of claim 1, wherein the historical factor information is timeliness and the target metric is time to completion.

3. The method of claim 2, wherein the historical factor information is based on geofencing.

4. The method of claim 1, wherein the historical factor information is financial, and the target metric is cost to completion.

5. The method of claim 1, wherein the historical factor information is credit worthiness, and the target metric is risk of default.

6. The method of claim 1, further comprising receiving, by the forecasting system bus, a virtual payment and distributing, by the forecasting system bus, the virtual payment to a virtual transaction account.

7. A project metric forecasting system comprising:
a target metric communication server in logical communication with a forecasting system bus and configured to receive a target metric for a project and transmit the target metric on the forecasting system bus;
a worker aggregation engine configured receive the target metric on the forecasting system bus and a plurality of electronic records from a worker database,
wherein the plurality of electronics records correspond to a plurality of workers who work on the project, wherein each of the plurality of electronic records comprises a worker data set;
a historical performance factoring node configured to gather historical factor information corresponding to each worker to associate the historical factor information with the worker data set;
a metric impact scoring server configured to receive the target metric on the forecasting system bus in response to a first exchange directive from a real-time bus supervisor,
wherein the metric impact scoring server is further configured to receive the worker data set from the worker aggregation engine via the forecasting system bus in response to a second exchange directive from the real-time bus supervisor,
wherein the metric impact scoring server is further configured to receive the historical factor information from the historical performance factoring node via the forecasting system bus in response to a third exchange directive from the real-time bus supervisor,
wherein the metric impact scoring server comprises:
a score computation engine configured to ingest the target metric, the worker data set, and the historical factor information, and assign to each of the plurality of workers, a metric impact score based on a score computation by the score computation engine;
wherein the metric impact scoring server is further configured to transmit on the forecasting system bus a first adjustment instruction to the target metric communication server configured to ingest the first adjustment instruction and in response to transmit a metric forecast to the forecasting system bus,
the first adjustment instruction comprising a directive to vary the target metric in response to the metric impact score;
a user interaction module configured to retrieve the metric forecast from the forecasting system bus,
a first visual cue displayed by the user interaction module in response in response to the metric forecast being equal to or less than the target metric; and
a second visual cue distinguishable from the first visual cue displayed by the user interaction module in response to the metric forecast being greater than the target metric, and
wherein the real-time bus supervisor is connected in logical communication with the forecasting system bus and is configured to direct the target metric communication server, the worker aggregation engine, the historical performance factoring node, and the metric impact scoring server, to execute a method of forecasting a metric through completion of the project in response to a plurality of predefined triggers.

8. The system of claim 7, wherein the historical factor information is timeliness.

9. The system of claim 7, wherein the target metric is time to completion.

10. The system of claim 7, wherein the historical factor information is based on geofencing.

11. The system of claim 7, wherein the historical factor information is financial, and the target metric is cost to completion.

12. The system of claim 7, wherein the historical factor information is credit worthiness, and the target metric is risk of default.

13. A method of guiding a project comprising the steps of:
retrieving, by a task identification server, a library of defined tasks from a task database in logical communication with the task identification server by a first task identification bus;
instructing, by a first task identification controller in logical communication with the first task identification bus, the task identification server to identify a first task;
transmitting, from the first task identification controller to an alert value computation engine, the first task, wherein the first task identification controller and the alert value computation engine are in logical communication via the first task identification bus;
assigning, by the alert value computation engine an alert value to the first task in response to an instruction from the first task identification controller;
comparing, by the alert value computation engine, the alert value to an alert condition;
displaying, by a user interaction module in logical communication with the first task identification controller via the first task identification bus, a first visual cue in response to the alert condition not being met;
increasing, by the alert value computation engine, the alert value by a first factor and directing by the alert value computation engine the user interaction module to adjust the first visual cue in a first way if the first task has a first successor task dependent upon the first task; and
increasing, by the alert value computation engine, the alert value by a second factor and directing by the alert value computation engine, the user interaction module to adjust the first visual cue a second way distinguishable from the first way if the first successor task has a second successor task dependent upon the first successor task.

14. The method of claim 13, wherein the alert condition is schedule.

15. The method of claim 13, wherein the alert condition is budget.

16. The method of claim 13, wherein the alert condition is a first capitalization ratio comprising a subcontractor liquidity estimate.

17. A project guidance system comprising:
a task database comprising a library of defined tasks;
a task identification server in logical communication with the task database via a first task identification bus, wherein the task identification server retrieves the library of defined tasks from the task database;
a first task identification controller in logical communication with the first task identification bus configured to instruct the task identification server to identify a first task;
an alert value computation engine in logical communication with the first task identification bus and configured to receive from the first task identification controller the first task, and in response to an instruction from the first task identification controller, to assign an alert value to the first task,
wherein the alert value computation engine is further configured to compare the alert value to an alert condition; and
a user interaction module in logical communication with the first task identification bus configured to display a first visual cue in response to an indication by the alert value computation engine that the alert condition is not met;
wherein the alert value computation engine is further configured to increase the alert value by a first factor and direct the user interaction module to adjust the first visual cue in a first way if the first task has a first successor task dependent upon the first task, and
wherein the alert value computation engine is further configured to increase the alert value by a second factor and direct the user interaction module to adjust the first visual cue a second way distinguishable from the first way if the first successor task has a second successor task dependent upon the first successor task.

18. The project guidance system of claim 17, wherein the alert condition is schedule.

19. The project guidance system of claim 17, wherein the alert condition is budget.

20. The project guidance system of claim 17, wherein the alert condition is a first capitalization ratio comprising a subcontractor liquidity estimate.
